(19) United States
(12) Patent Application Publication
(10) Pub. No.: US 2007/0246679 A1
(43) Pub. Date: Oct. 25, 2007

(54) Valve, especially for use in fire-fighting

(75) Inventors: Jochen Max Widenmann, Ulm (DE); Johann Ambrosi, Herbrechtingen (DE)

Correspondence Address: CARLSON, GASKEY & OLDS, P.C., 400 WEST MAPLE ROAD, SUITE 350, BIRMINGHAM, MI, 48009, US

(73) Assignee: Max Widenmann KG Armaturenfabrik

(21) Appl. No.: 11/408,581

(22) Filed: Apr. 21, 2006

(51) Int. Cl. F16K 1/00

(52) U.S. Cl. 251/324

(57) ABSTRACT

A valve, in particular a valve for use in fire-fighting, includes a valve housing and components being in frictional engagement with each other or with the housing during use of the valve. At least one of the frictional engaging components is mounted in the housing so as to be removable for maintenance or replacement.

### TECHNICAL FIELD

The invention relates to a valve, in particular to a valve for use in fire-fighting.

### BACKGROUND OF THE INVENTION

Fire-fighting valves mainly having two connecting ports so that flow through the valve can be affected in either of two opposite directions are known, for example, as oblique-seat valves. Such valves are used as they facilitate an approximately straight flow therethrough in order to obtain the least possible pressure loss in the valve, especially if the media flowing through the valve are more flow-sensitive than water without additives. One of the connecting ports, fitted in most cases with a cap nut, is connected either to a hydrant, so that the water drawn from that source will flow through a hose that is connected to the other port and forms the supply line between the hydrant and the fire-fighting pump, or it is connected to the fire-fighting pump with the water reaching the valve coming from the hose that forms the supply line. In the first situation, water flows from the screw port to the hose port and, in the second situation, water passes from the hose port to the screw port. At the hose port, the hose may be kinked or cracked. Sometimes this can be avoided by using special elbow bends. If such valves were designed for wide diameter coupling and hoses, the forces acting on the large cross section become so strong in the case of high pressures, that the valve-closing handwheels must have a diameter sufficient to obtain the necessary torque. Little can be done about this problem even by using special spindle threads, for instance expensive multi-thread types. Therefore, it is necessary in valves designed for large flow diameters, such as 100 mm or more, to provide pressure relief to reduce the forces required for closing the valve. Since the valves are used for flow in either of two directions, pressure relief must be available in either flow direction. Where connecting channels from chambers situated ahead or behind the closing devices are used for pressure relief, however, such connecting channels are likely to become soiled or frozen in the winter, because of their small internal diameter.

Therefore, the primary demands on a valve of the type described above, are a large flow cross section and pressure relief in both flow directions without the use of narrow channels which might become soiled or frozen. The valve should enable easy opening and closing operation using a handwheel with a diameter that is as small as possible. Furthermore, the valve should be constructed so that the risk of kinking hoses connected in both flow directions is avoided.

A valve meeting the above demands is known from German Utility Model No. 81 23 268.3, which is incorporated herein by reference. The valve body of this known valve is a circular (annular) piston that is axially displaceable by rotating an actuating spindle. The annular piston is formed as a hollow cylinder with radially inwardly directed ribs supporting a hub containing a female thread in engagement with the thread on the spindle. On its outer circumferential surface, the annular piston has different diameter end sections separated by a circular groove extending in the axial direction of the annular piston. The valve housing forms a guide cylinder for the annular piston and the surface of the guide cylinder forms a groove defining a space encircling the annular piston. The actual dimensions of the circular groove in the annular piston and of the encircling space in the guide cylinder surface are such that in the closed and opened positions of the annular piston, the circular groove is in communication with the encircling space formed in the guide cylinder. One of the two connecting ports formed in or supported on the valve housing extends obliquely downward relative to the other connecting port which is disposed for operation in a substantially horizontal axial position. The pressure compensation for operation in either flow direction is achieved without narrow connecting spaces. Due to the angular disposition of the connecting ports relative to one another, provided for in the construction of the valve housing, it is unnecessary to use special bends for hose connections.

In fire-fighting situations not only clean water but mainly water from public waters is used that is more or less soiled. The soiling supports chemical reactions in the valves that are usually made of aluminum alloys, resulting in corrosion of some materials. Since corrosion is a time dependent process it may be slowed down by consistent rinsing and draining of the valves after use, but normally it cannot be completely avoided. A possible solution to solve this problem is the use of high-grade materials having better chemical resistance characteristics, like brass or stainless steel. However, valve components made of high-grade materials are not only more expensive but also render the handling of the valve more intricate. Moreover, because of the significantly higher weight of valves with components made of such materials, the load capacity of a fire-fighting truck may be impaired.

It is therefore an object of the invention to provide a valve that can be adapted to the regional water quality in an optimum manner.

### SUMMARY OF THE INVENTION

The valve according to the invention comprises a valve housing and components being in frictional engagement with each other or with the housing during use of the valve. At least one of the frictionally engaging components is mounted in the housing so as to be removable for maintenance or replacement. The invention is based on the finding that, among the valve components getting in contact with the media flowing through the valve, those components that are in frictional engagement suffer from deterioration most. The invention provides the possibility of removing critical valve components and thus allows for a flexible adaptation of the valve to different water qualities. For example, a basic version of the valve can be equipped with components made of a standard material like an aluminum alloy or even a synthetic material. When it turns out that in the local region in which the valve is normally used, some components fail due to corrosion within a short period of time, these components may be easily maintained, or replaced by components made of the same or of a high-grade material. Accordingly, the durability and the economic efficiency of the valve (under particular consideration of the maintenance costs) can be improved as required.

Maintenance or replacement of the valve according to the invention can be particularly facilitated by a housing that has an opening through which the frictional engaging component can be removed. The opening is closed by a separate lid during use of the valve.

In a preferred embodiment of the invention the housing defines a hollow cylinder in which a guide bush is held. The valve comprises an annular piston that is slidably held in the guide bush. A so-formed annular piston valve is especially suitable for use in fire-fighting equipment. The guide bush, which is in frictional engagement with the annular piston due to the sliding fit, can be made of a high-grade material while the housing can still be formed of an aluminum alloy, for example.

According to one aspect of the invention, the frictional engaging component is part of a valve member and separable from the valve member. Thus, it is not necessary that the whole valve member is made of a high-grade material, or that the whole member is maintained or replaced in case of failure.

Another critical valve member is the valve body. Preferably a valve according to the invention comprises an annular piston that includes an inner bearing sleeve and an outer sleeve slid onto the inner bearing sleeve, the outer sleeve being in a sliding fit with a guiding portion in the housing. The sleeves may be made of different materials.

According to an advantageous valve body construction, the annular piston further includes a gasket ring held in a press fit between a flange of the inner bearing sleeve and the outer sleeve. The press fit can be secured by bolts connecting the inner bearing sleeve to the outer sleeve.

These and other features of the present invention can be best understood from the following specification and drawings, the following of which is a brief description.

### BRIEF DESCRIPTION OF THE DRAWINGS

FIG. 1 shows an exploded view of the housing components and the handwheel of a valve according to the invention;

FIG. 2 shows a sectional view of the valve; and

FIG. 3 shows an exploded view of the piston parts and the spindle of the valve.

### DETAILED DESCRIPTION OF THE PREFERRED EMBODIMENT

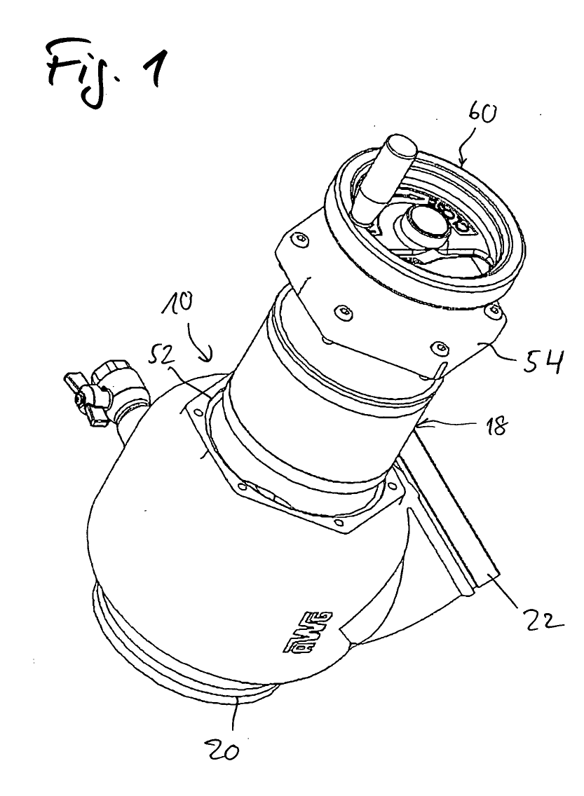

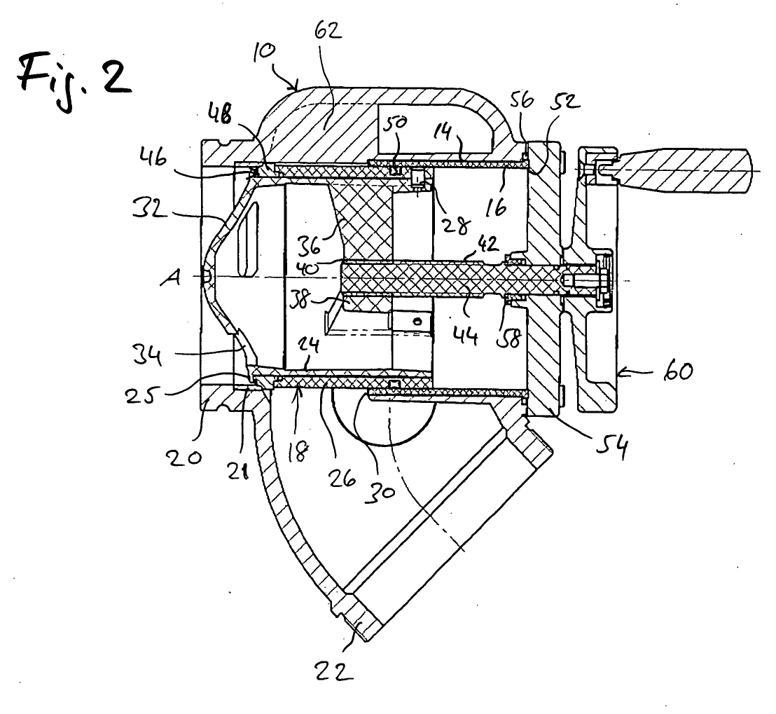

The valve illustrated in FIGS. 1 and 2 includes a die-cast housing 10 made of an aluminum alloy. The housing 10 forms a hollow cylinder 14 in which a guide bush 16 is held. The inner surface of the guide bush 16 provides a sliding fit for an annular piston 18 that serves as the closing member (valve body) of the valve.

A connecting port 20, extending in the axial direction of the cylinder 14, is formed in one piece with the housing 10. A bushing 21 made of stainless steel is inserted into the port 20 and forms a valve seat for the annular piston 18. Another port 22, also formed as an integral part of the housing 10, has substantially the same inside diameter as the port 20 and is inclined obliquely downward with respect to the port 20. For operation of the valve, the axis A of port 20 is horizontal. A hose-coupling device (not illustrated) such as a “Storz” quick-coupling device, can be screwed onto port 22.

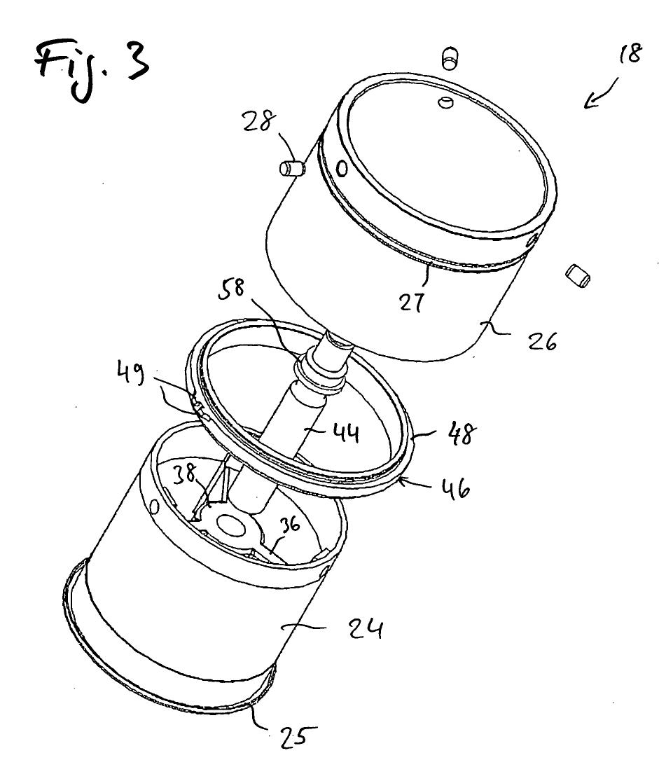

As can be seen in FIGS. 2 and 3, the annular piston 18 is a hollow cylindrical member that is mainly composed of an inner bearing sleeve 24, an outer sleeve 26 and a gasket ring 46. On its inside surface, the inner bearing sleeve 24 of the annular piston 18 has radially inwardly extending ribs 36, spaced angularly apart, and supporting a hub 38 with a female thread 40 in the inside surface of the hub 38. The thread 40 of the hub 38 is in engagement with a matching male thread 42 of an actuating spindle 44. On its outside surface, the inner bearing sleeve 24 has a cranked flange 25 formed at one axial end. The inner bearing sleeve 24 is integrally formed with an axial front end cover 32 of the annular piston 18 having several bores 34. The outer bearing sleeve 26 has an encircling groove 27 into which an O-ring 50 is inserted. The gasket ring 46, which is made of an elastomeric material, has an encircling collar 48. An axial groove is formed on the collar 48 between two projections 49.

The annular piston 18 is assembled in the following manner: The gasket ring 46 and the outer sleeve 26 are slid onto the inner bearing sleeve 24. The gasket ring 46 is held in an axial press fit (biased) between the outer sleeve 26 and the cranked flange 25 of the inner bearing sleeve 24. The axial press fit is secured by bolts 28 radially extending through corresponding openings formed in the inner and outer sleeves 24, 26. As can be seen in FIG. 2, the gasket ring 46 enters a form-fit between the cranked flange 25 and the axial end of the outer sleeve 26. Thus, under no circumstances can the gasket ring 46 slip down from the annular piston 18.

The annular piston 18 is slidably held in the guide bush 16 with the O-ring 50 sealing the annular piston 18 relative to the guide bush 16. The annular piston 18 is axially movable in a manner described further below. In the closed position of the valve shown in FIG. 2, the gasket ring 46 of the annular piston 18 rests on the valve seat formed by the bush 21. In this position the port 22 is closed. In particular, the O-ring 50 and the gasket ring 46 of the annular piston 18 seal an opening 30 of the port 22. In the open position of the annular piston 18, only the front end cover 32 of the annular piston 18 extends into the direct flow through opening 30. Because of the bores 34 formed in the front end cover 32, the annular piston 18 is always pressure relieved, except for the closed position shown in FIG. 2.

At its rear side (the right side in FIG. 2) the housing 10 has an opening 52 that corresponds to the rear axial end of the cylinder 14. The opening 52 is closed by a separate lid 54 that is connected to the housing 10 by several screws, for example. The lid 54 is also used to axially secure the guide bush 16 in the housing 10. To this end, the guide bush 16 has an annular collar 56 that is clamped between the housing 10 and the lid 54. The collar 56 only slightly exceeds the outer diameter of the guide bush 16 and is surrounded by an adjoining O-ring. The O-ring seals the housing 10 and the lid 54 relative to the outside on the one hand, and also seals the guide bush 16 relative to the cylinder 14 of the housing 10 on the other hand.

The actuating spindle 44 is supported in the lid 54 by a bearing ring 58. The lid 54, the bearing ring 58 and the spindle 44 are detachable from each other. The end of the spindle 44 projecting outwardly from the lid 54 is fixed to a handwheel 60. Rotation of the handwheel 60 is transformed by the spindle thread 42 cooperating with the thread 40 of the hub 38 into an axial movement of the annular piston 18. Unwanted rotation of the annular piston 18 is prevented in that the groove formed between the projections 49 on the gasket ring 46 is engaged by an axially extending rib 62 integrally formed with the housing 10. Due to the pressure relieving bores 34 in the front end cover 32 of the annular piston 18, the actuating force required to rotate the handwheel 60 is minimized.

After use of the valve, the lid 54 can be removed to check the condition of the valve components in the housing 10. The opening 52 allows for an easy deinstallation of the guide bush 16 and the annular piston 18, if required. The outer sleeve 26 of the annular piston 18 can be separated from the bearing sleeve 24 and be attended to separately. Further, the spindle 44 and the bearing ring 58 are also easy to be maintained or replaced because they are separable from the lid 54 as mentioned before.

Depending on the quality of the water used for fire-fighting, one or more of the before-recited valve components may be made of an aluminum alloy, a synthetic material like POM (polyoxymethylene), an alloy having a high share of copper like brass or red brass (red bronze), or stainless steel.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A valve, in particular a valve for use in fire-fighting, said valve comprising
a valve housing, and
frictional engaging components being in frictional engagement with each other or with said housing during use of said valve,
at least one of said frictional engaging components being mounted in said housing so as to be removable for maintenance or replacement.

2. The valve according to claim 1, wherein said housing has an opening through which said at least one of said frictional engaging components can be removed, said opening being closed by a separate lid during use of said valve.

3. The valve according to claim 2, comprising an annular piston, said annular piston being axially displaceable by a spindle, said spindle being supported in said lid, said spindle being removable from said lid.

4. The valve according to claim 3, wherein said spindle is supported in said lid by a bearing ring, said bearing ring being separable from at least one of said lid and said spindle.

5. The valve according to claim 1, wherein said housing defines a hollow cylinder in which a guide bush is held, said valve comprising an annular piston, said annular piston being slidably held in said guide bush.

6. The valve according to claim 5, further comprising a lid for closing an opening of said housing, said guide bush having an annular collar that is clamped between said housing and said lid, so as to axially secure said guide bush in said housing.

7. The valve according to claim 1, wherein said frictional engaging component is part of a valve member, said frictional engaging component being separable from said valve member.

8. The valve according to claim 1, comprising an annular piston that includes an inner bearing sleeve and an outer sleeve slid onto said inner bearing sleeve, said outer sleeve being in a sliding fit with a guiding portion in said housing.

9. The valve according to claim 8, wherein said annular piston further includes a gasket ring held in a press fit between a flange of said inner bearing sleeve and said outer sleeve.

10. The valve according to claim 9, wherein said press fit is secured by bolts connecting said inner bearing sleeve to said outer sleeve.

11. The valve according to claim 8, further comprising a port having an opening, said outer sleeve having an encircling groove with an O-ring inserted in said groove, said annular piston being movable into a position where said O-ring and said gasket ring seal said opening.

12. The valve according to claim 1, wherein at least one of said frictional engaging components is made of one of the following materials: a synthetic material, an alloy having a high share of copper, stainless steel.
